(19) United States
(12) Patent Application Publication
(10) Pub. No.: US 2026/0322461 A1
(43) Pub. Date: Oct. 15, 2026

(54) REDUCTION OF CSI COEFFICIENTS IN CSI REPORTING

(71) Applicant: HUAWEI TECHNOLOGIES CO., LTD., Shenzhen (CN)

(72) Inventors: Salah Eddine Hajri, Lund (SE); Thorsten Schier, Lund (SE); Yuan Li, Beijing (CN)

(73) Assignee: HUAWEI TECHNOLOGIES CO., LTD., Shenzhen (CN)

(21) Appl. No.: 19/466,762

(22) Filed: Feb. 2, 2026

Related U.S. Application Data
(63) Continuation of application No. PCT/CN2023/111099, filed on Aug. 3, 2023.

(51) Int. Cl. H04B 7/06

(52) U.S. Cl. CPC H04B 7/0658

(57) ABSTRACT

Embodiments of the application relate to first and second communication devices for reduction of channel state information (CSI) coefficients in CSI reporting. The first communication device transmits a CSI report to the second communication device and the CSI report indicates a subset of CSI coefficients of a complete set of CSI coefficients according to a CSI omitting rule. The second communication device receives the CSI report and determine the complete set of CSI coefficients based on the subset of CSI coefficients in the CSI report. Furthermore, embodiments of the application also relate to corresponding methods and a computer program.

### CROSS-REFERENCE TO RELATED APPLICATION

This application is a continuation of International Application No. PCT/CN2023/111099, filed on Aug. 3, 2023, the disclosure of which is hereby incorporated by reference in its entirety.

### TECHNICAL FIELD

Embodiments of the application relate to first and second communication devices for reduction of CSI coefficients in CSI reporting. Furthermore, embodiments of the application also relate to corresponding methods and a computer program.

### BACKGROUND

Artificial intelligence (AI), and more precisely machine learning (ML), methods have proven their worth in a multitude of fields, covering different problems including classification, regression, pattern detection, dimensionality reduction and interaction with dynamic environments. Consequently, machine learning is expected to become a primordial technology in wireless communication networks, in the radio access and core networks. Indeed, machine learning models are capable of capturing non-trivial dependencies and patterns in the data that conventional signal processing techniques, typically used in air interface, are incapable of leveraging. Consequently, exploiting their potential in the air interface of wireless communication networks could deliver non-negligible performance gains, in terms of the main network key performance indicators (KPI), such as throughput, latency, reliability and energy efficiency.

In this context, 3GPP agreed a study item in Rel-18, Study on AI/ML for the new radio (NR) air interface, to study the potential enhancements, performance gain, general framework and standard impact that machine learning methods would entail on the air interface. Several important use cases are beam management, channel state information (CSI) reporting and positioning performance enhancements.

While these particular use cases are quite challenging and important, given that NR is a beamforming-based air interface, it is worth highlighting that the potential of AI/ML can be leveraged in other important use cases such as link adaptation enhancements, hardware impairment and mobile terminal (MT)/gNB-side implementation enhancement, L1/L2-mobility support enhancement, adaptation to different traffic types, and cross link interference measurement and management.

### SUMMARY

An objective of embodiments of the application is to provide a solution which mitigates or solves the drawbacks and problems of conventional solutions.

Another objective of embodiments of the application is to provide a solution for reduced payload of CSI and data reports in communication systems.

The above and further objectives are solved by the subject matter of the independent claims. Further embodiments of the application can be found in the dependent claims.

According to a first aspect of the application, the above mentioned and other objectives are achieved with a first communication device for a communication system, the first communication device being configured to:
measure a set of reference signals transmitted in a set of transmit beams of a second communication device and received in a set of receive beams of the first communication device;
determine a set of channel state information (CSI) coefficients based on the set of measured reference signals;
reduce the set of CSI coefficients to a subset of CSI coefficients by omitting at least one CSI coefficient based on a CSI omitting rule; and
transmit a CSI report to the second communication device, the CSI report indicating the subset of CSI coefficients.

An advantage of the first communication device according to the first aspect is that the first communication device permits CSI reporting overhead reduction with minimum information loss. Thus, more efficient reporting resource usage is possible in the communication system. This can be leveraged when reporting resources are unable to fit the entire payload of reports, when higher priority signals need to be transmitted or when power consumption at the first communication device is targeted. Moreover, a novel CSI omission rule is defined which is suitable for ML operations in the air interface which guarantees the quality of collected training data using existing CSI framework of standardized communication systems such as 3GPP NR. Further, the novel CSI omission rule allows to retrieve the omitted CSI coefficients with limited complexity at the second communication device, i.e., at the receiver side.

In an embodiment, the CSI omitting rule comprises omitting the CSI coefficient in the spatial domain and/or in the time domain.

An advantage with this embodiment is that both spatial and time domain beam and beam pair prediction can be supported. Additionally, depending on the utilized beam codebooks, in addition to the velocities of the respective communication devices, and deployment scenario, one or more dimensions can be prioritized during omission. For example, in case of fast moving communication devices, the omission of coefficients in the time domain may be reduced in order to capture the fast varying beams or beam pairs.

In an embodiment, the CSI omitting rule comprises omitting the CSI coefficient with any of: a spatial offset, a time offset, a spatial sampling rate, and a time sampling rate.

An advantage with this embodiment is that the payload of the CSI report can be reduced substantially while minimizing information loss. As the first communication device can choose the parameters of the omission, i.e., the spatial sampling offset, the time sampling offset, the spatial sampling rate, and the time sampling rate, the first communication device can make the omission choice so that reconstruction of the entire report at the second communication device can be performed accurately.

In an embodiment, the CSI omitting rule comprises omitting the CSI coefficient for one or more of: a transmit beam, a receive beam, and a beam pair comprising a transmit beam and a receive beam.

An advantage with this embodiment is that both beam and beam pair prediction can be supported.

In an embodiment, the CSI omitting rule comprises omitting the CSI coefficient for a time series of CSI coefficients in the set of CSI coefficients.

An advantage with this embodiment is that time domain beam and beam pair prediction can be supported. For this case, the reported CSI coefficients constitute a time series of measurements per beam or beam pair. Hence, omission according to the proposed method will not break the time structure of the CSI report, i.e., measurement time tags and order of the measurements.

In an embodiment, the set of CSI coefficients comprises one or more of: a reference resource indicator, a beam index, a reference resource pair indicator, a beam pair index, a reference signal received power, and a signal-to-noise and interference ratio.

An advantage with this embodiment is that all beam or beam pair reporting quantities can be supported, whether interference measurements are included or not.

In an embodiment, the CSI omitting rule comprises omitting the CSI coefficient by reducing the set of measured reference signals to a subset of measured reference signals.

An advantage with this embodiment is that non-periodic omission patterns in the spatial domain can be supported. In this case, the omission of measurements on specific resources can be further tailored to the propagation environment.

In an embodiment, the subset of measured reference signals is at least one preconfigured reference signal group in channel measurement resources and/or interference measurement resources.

An advantage with this embodiment is that the second communication device can configure the reference signal resource groups based on its proprietary beam implementation, without having to disclose any further information. Additionally, the second communication device can further optimize the reference signal resources grouping on prior collected data for the same or different first communication device.

In an embodiment, the first communication device being configured to:
receive a first control signal from the second communication device, the first control signal indicating the CSI omitting rule.

An advantage with this embodiment is that different omission rules can be supported and the choice of the omission rule to use can be based on side information available at the second communication device, such as the spatial structure of the propagation channel, other measurements from the same or different first communication device, the beam codebook used at the second communication device and the average beam dwelling time.

In an embodiment, the first control signal is a radio resource control (RRC) signal.

An advantage with this embodiment is that the omission rule to be used can be part of the CSI, radio resource measurement or data collection configurations in RRC.

In an embodiment, the first communication device being configured to:
receive a second control signal from the second communication device, the second control signal indicating an activation or a deactivation of the CSI omitting rule.

An advantage with this embodiment is that the second communication device can control the applicability of omission rules. Indeed, the requirements for collected measurements can differ depending on whether they are used for training, inference or monitoring of the machine learning model or models for beam or beam pair prediction. Consequently, in some critical cases, the second communication device may deactivate the CSI omitting rule hence giving higher priority to obtaining the entire CSI measurement report, e.g., when a drop in the model accuracy is detected.

In an embodiment, the second control signal is a downlink control information or a downlink medium access control control element.

An advantage with this embodiment is that the activation or deactivation command can be conveyed with minimum delay. Consequently, timely adaptation to the model performance and propagation conditions can be achieved.

In an embodiment, the CSI report further indicates information about the omission of the CSI coefficient in the spatial domain and/or in the time domain with any of: a spatial offset, a time offset, a spatial sampling rate, and a time sampling rate; and/or the omission of the CSI coefficient by reducing the set of measured reference signals to a subset of measured reference signals based on at least one preconfigured reference signal group in channel measurement resources and/or interference measurement resources.

An advantage with this embodiment is that there will be no ambiguity at the second communication device when decoding the CSI report received from the first communication device and a proper subsequent reconstruction could be performed.

According to a second aspect of the application, the above mentioned and other objectives are achieved with a second communication device for a communication system, the second communication device being configured to:
transmit a set of reference signals in a set of transmit beams of the second communication device to a set of receive beams of a first communication device;
receive a CSI report from the first communication device, the CSI report indicating a subset of CSI coefficients of a set of CSI coefficients based on a CSI omitting rule, the set of CSI coefficients corresponding to one or more of: the set of transmit beams, the set of receive beams and a set of beam pairs comprising the set of transmit beams and the set of receive beams; and
determine the set of CSI coefficients based on the subset of CSI coefficients.

An advantage of the second communication device according to the second aspect is that more efficient reporting resource usage is possible in the communication system. This can be leveraged when reporting resources are unable to fit the entire payload of reports, when higher priority signals need to be transmitted or when power consumption at the first communication device is targeted. Moreover, a novel CSI omission rule is defined which is suitable for ML operations in the air interface which guarantees the quality of collected training data using existing CSI framework of standardized communication systems such as 3GPP NR. Further, the novel CSI omission rule allows to retrieve the omitted CSI coefficients with limited complexity at the second communication device, i.e., at the receiver side.

In an embodiment, the second communication device being configured to:
determine the set of CSI coefficients based on interpolating or extrapolating the subset of CSI coefficients.

An advantage with this embodiment is that the second communication device can reconstruct, at least partially, the omitted CSI coefficients. Using interpolation, e.g., polynomial, spline or linear interpolation and extrapolation, based on the received subset of CSI coefficients enable to reconstruct the entire report with acceptable accuracy.

In an embodiment,
the second communication device being configured to:
   transmit a first control signal to the first communication device, the first control signal indicating the CSI omitting rule.

An advantage with this embodiment is that different omission rules can be supported and the choice of the omission rule to use can be based on side information available at the second communication device, such as the spatial structure of the propagation channel, other measurements from the same or different first communication device, the beam codebook used at the second communication device and the average beam dwelling time.

In an embodiment,
the first control signal is a RRC signal.

An advantage with this embodiment is that the omission rule to be used can be part of the CSI, radio resource measurement or data collection configurations in RRC.

In an embodiment,
the CSI omitting rule comprises omitting at least one CSI coefficient in the spatial domain and/or in the time domain.

An advantage with this embodiment is that both spatial and time domain beam and beam pair prediction can be supported. Additionally, depending on the utilized beam codebooks, in addition to the velocities of the respective communication devices, and deployment scenario, one or more dimensions can be prioritized during omission. For example, in case of fast moving communication devices, the omission of coefficients in the time domain may be reduced in order to capture the fast varying beams or beam pairs.

In an embodiment,
the CSI omitting rule comprises omitting the CSI coefficient with any of: a spatial offset, a time offset, a spatial sampling rate, and a time sampling rate.

An advantage with this embodiment is that the payload of the CSI report can be reduced substantially while minimizing information loss. As the first communication device can choose the parameters of the omission, i.e., the spatial sampling offset, the time sampling offset, the spatial sampling rate, and the time sampling rate, the first communication device can make the omission choice so that reconstruction of the entire report at the second communication device can be performed accurately.

In an embodiment,
the CSI omitting rule comprises omitting the CSI coefficient for one or more of: a transmit beam, a receive beam, and a beam pair comprising a transmit beam and a receive beam.

An advantage with this embodiment is that both beam and beam pair prediction can be supported.

In an embodiment,
the CSI omitting rule comprises omitting the CSI coefficient for a time series of CSI coefficients in the set of CSI coefficients.

An advantage with this embodiment is that time domain beam and beam pair prediction can be supported. For this case, the reported CSI coefficients constitute a time series of measurements per beam or beam pair. Hence, omission according to the proposed method will not break the time structure of the CSI report, i.e., measurement time tags and order of the measurements.

In an embodiment,
the set of CSI coefficients comprises one or more of: a reference resource indicator, a beam index, a reference resource pair indicator, a beam pair index, a reference signal received power, and a signal-to-noise and interference ratio.

An advantage with this embodiment is that all beam or beam pair reporting quantities can be supported, whether interference measurements are included or not.

In an embodiment, the CSI omitting rule comprises omitting at least one CSI coefficient by reducing the set of measured reference signals to a subset of measured reference signals.

An advantage with this embodiment is that non-periodic omission patterns in the spatial domain can be supported. In this case, the omission of measurements on specific resources can be further tailored to the propagation environment.

In an embodiment,
the subset of measured reference signals is at least one preconfigured reference signal group in channel measurement resources and/or interference measurement resources.

An advantage with this embodiment is that the second communication device can configure the reference signal resource groups based on its proprietary beam implementation, without having to disclose any further information. Additionally, the second communication device can further optimize the reference signal resources grouping on prior collected data for the same or different first communication device.

In an embodiment, the second communication device being configured to:
transmit a second control signal to the first communication device, the second control signal indicating an activation or a deactivation of the CSI omitting rule.

An advantage with this embodiment is that the second communication device can control the applicability of omission rules. Indeed, the requirements for collected measurements can differ depending on whether they are used for training, inference or monitoring of the machine learning model or models for beam or beam pair prediction. Consequently, in some critical cases, the second communication device may deactivate the CSI omitting rule hence giving higher priority to obtaining the entire CSI measurement report, e.g., when a drop in the model accuracy is detected.

In an embodiment,
the second control signal is a downlink control information or a downlink medium access control control element.

An advantage with this embodiment is that the activation or deactivation command can be conveyed with minimum delay. Consequently, timely adaptation to the model performance and propagation conditions can be achieved.

In an embodiment,
the CSI report further indicates information about an omission of at least one CSI coefficient in the spatial domain and/or in the time domain with any of: a spatial offset, a time offset, a spatial sampling rate, and a time sampling rate; and/or an omission of at least one CSI coefficient by reducing the set of measured reference signals to a subset of measured reference signals based on at least one preconfigured reference signal group in channel measurement resources and/or interference measurement resources.

An advantage with this embodiment is that there will be no ambiguity at the second communication device when decoding the CSI report received from the first communication device and a proper subsequent reconstruction could be performed.

According to a third aspect of the application, the above mentioned and other objectives are achieved with a method for a first communication device, the method comprises:
measuring a set of reference signals transmitted in a set of transmit beams of a second communication device and received in a set of receive beams of the first communication device;
determining a set of channel state information, CSI, coefficients based on the set of measured reference signals;
reducing the set of CSI coefficients to a subset of CSI coefficients by omitting at least one CSI coefficient based on a CSI omitting rule; and
transmitting a CSI report to the second communication device, the CSI report indicating the subset of CSI coefficients.

The method according to the third aspect can be extended into embodiments corresponding to the embodiments of the first communication device according to the first aspect. Hence, an implementation form of the method comprises the feature(s) of the corresponding implementation form of the first communication device.

The advantages of the methods according to the third aspect are the same as those for the corresponding embodiments of the first communication device according to the first aspect.

According to a fourth aspect of the application, the above mentioned and other objectives are achieved with a method for a second communication device, the method comprises:
transmitting a set of reference signals in a set of transmit beams of the second communication device to a set of receive beams of a first communication device;
receiving a CSI report from the first communication device, the CSI report indicating a subset of CSI coefficients of a set of CSI coefficients based on a CSI omitting rule, the set of CSI coefficients corresponding to one or more of: the set of transmit beams, the set of receive beams and a set of beam pairs comprising the set of transmit beams and the set of receive beams; and
determining the set of CSI coefficients based on the subset of CSI coefficients.

The method according to the fourth aspect can be extended into embodiments corresponding to the embodiments of the second communication device according to the second aspect. Hence, an implementation form of the method comprises the feature(s) of the corresponding implementation form of the second communication device.

The advantages of the methods according to the fourth aspect are the same as those for the corresponding embodiments of the second communication device according to the second aspect.

Embodiments of the application also relate to a computer program, characterized in program code, which when run by at least one processor causes the at least one processor to execute any method according to embodiments of the application. Further, embodiments of the application also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the application will be apparent from the following detailed description.

### BRIEF DESCRIPTION OF THE DRAWINGS

The appended drawings are intended to clarify and explain different embodiments of the application, in which:

FIG. 1 shows a first communication device according to an embodiment of the application;

FIG. 2 shows a flow chart of a method for a first communication device according to an embodiment of the application;

FIG. 3 shows a second communication device according to an embodiment of the application;

FIG. 4 shows a flow chart of a method for a second communication device according to an embodiment of the application;

FIG. 5 illustrates a communication system according to embodiments of the application;

FIG. 6 illustrates omission of CSI coefficients in the spatial domain according to an embodiment of the application;

FIG. 7 illustrates omission of CSI coefficients in the time domain according to an embodiment of the application; and

FIG. 8 shows a signaling diagram illustrating further embodiments of the application.

### DETAILED DESCRIPTION

With the advent of ML-based beam management, the payload of reported beam measurements, for training, inference and/or monitoring is expected to increase. For example, narrower beams are used hence the increase in the variables in the spatial domain. Further, time-domain beam prediction requires the reporting of measurement time series to be used as input for the network side model or as output of the user equipment (UE)-side model.

Hence, increase of payload of beam management reporting implies that further aspects of CSI reporting need to be considered. This includes CSI reporting resource allocation, time domain behavior for reporting and reporting timeline requirements. Additionally, CSI omission rules, which e.g., may apply in case of insufficient resources to convey all CSI reports, need to be amended to support new requirements for efficient CSI reporting. Consequently, adaptive and efficient omission rules for beam management CSI reporting needs to be provided in order to accommodate less beam reporting payload. Therefore, the present disclosure relates to first and second communication devices for reduced and efficient CSI reporting that may be used for beam management in wireless communication systems.

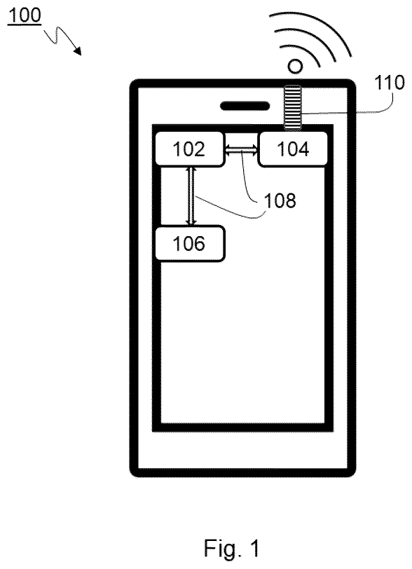

FIG. 1 shows a first communication device 100 according to an embodiment of the application. In the embodiment shown in FIG. 1, the first communication device 100 comprises a processor 102, a transceiver 104 and a memory 106. The processor 102 is coupled to the transceiver 104 and the memory 106 by communication means 108 known in the art. The first communication device 100 may be configured for wireless communications in a communication system. The wireless communication capability may be provided with an antenna or antenna array 110 coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 104 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset.

That the first communication device 100 is configured to perform certain actions can in this disclosure be understood to mean that the first communication device 100 comprises suitable means, such as e.g., the processor 102 and the transceiver 104, configured to perform the actions.

According to embodiments of the application the first communication device 100 is configured to measure a set of reference signals transmitted in a set of transmit beams of a second communication device 300 and received in a set of receive beams of the first communication device 100; determine a set of channel state information (CSI) coefficients based on the set of measured reference signals; reduce the set of CSI coefficients to a subset of CSI coefficients by omitting at least one CSI coefficient based on a CSI omitting rule; and transmit a CSI report 510 to the second communication device 300, the CSI report 510 indicating the subset of CSI coefficients.

Furthermore, in an embodiment of the application, the first communication device 100 for a communication system 500 comprises a processor configured to: measure a set of reference signals transmitted in a set of transmit beams of a second communication device 300 and received in a set of receive beams of the first communication device 100; determine a set of CSI coefficients based on the set of measured reference signals; reduce the set of CSI coefficients to a subset of CSI coefficients by omitting at least one CSI coefficient based on a CSI omitting rule. The first communication device 100 comprises a transceiver configured to transmit a CSI report 510 to the second communication device 300, the CSI report 510 indicating the subset of CSI coefficients.

Moreover, in yet another embodiment of the application, the first communication 100 for a communication system 500 comprises a processor and a memory having computer readable instructions stored thereon which, when executed by the processor, cause the processor to: measure a set of reference signals transmitted in a set of transmit beams of a second communication device 300 and received in a set of receive beams of the first communication device 100; determine a set of CSI coefficients based on the set of measured reference signals; reduce the set of CSI coefficients to a subset of CSI coefficients by omitting at least one CSI coefficient based on a CSI omitting rule; and transmit a CSI report 510 to the second communication device 300, the CSI report 510 indicating the subset of CSI coefficients.

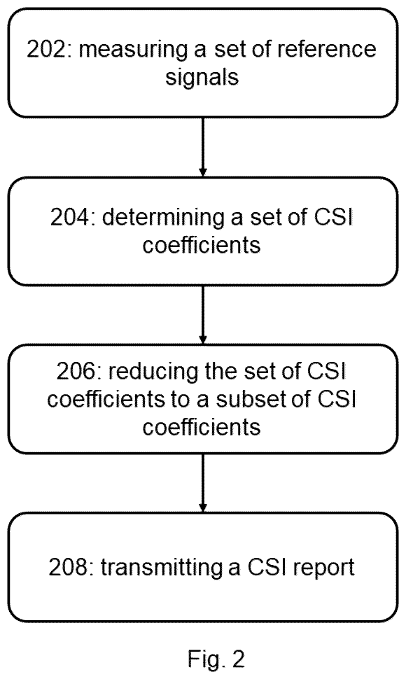

FIG. 2 shows a flow chart of a corresponding method 200 which may be executed in a first communication device 100, such as the one shown in FIG. 1. The method 200 comprises measuring 202 a set of reference signals transmitted in a set of transmit beams of a second communication device 300 and received in a set of receive beams of the first communication device 100; determining 204 a set of CSI coefficients based on the set of measured reference signals; reducing 206 the set of CSI coefficients to a subset of CSI coefficients by omitting at least one CSI coefficient based on a CSI omitting rule; and transmitting 208 a CSI report 510 to the second communication device 300, the CSI report 510 indicating the subset of CSI coefficients.

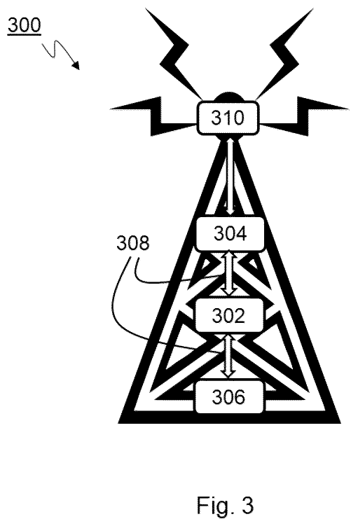

FIG. 3 shows a second communication device 300 according to an embodiment of the application. In the embodiment shown in FIG. 3, the second communication device 300 comprises a processor 302, a transceiver 304 and a memory 306. The processor 302 is coupled to the transceiver 304 and the memory 306 by communication means 308 known in the art. The second communication device 300 further comprises an antenna or antenna array 310 coupled to the transceiver 304, which means that the second communication device 300 is configured for wireless communications in a communication system.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 304 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the second communication device 300 is configured to perform certain actions can in this disclosure be understood to mean that the second communication device 300 comprises suitable means, such as e.g., the processor 302 and the transceiver 304, configured to perform the actions.

According to embodiments of the application, the second communication device 300 is configured to transmit a set of reference signals in a set of transmit beams of the second communication device 300 to a set of receive beams of a first communication device 100; receive a CSI report 510 from the first communication device 100, the CSI report 510 indicating a subset of CSI coefficients of a set of CSI coefficients based on a CSI omitting rule, the set of CSI coefficients corresponding to one or more of: the set of transmit beams, the set of receive beams and a set of beam pairs comprising the set of transmit beams and the set of receive beams; and determine the set of CSI coefficients based on the subset of CSI coefficients.

Furthermore, in an embodiment of the application, the second communication device 300 for a communication system 500 comprises a transceiver configured to: transmit a set of reference signals in a set of transmit beams of the second communication device 300 to a set of receive beams of a first communication device 100; and receive a CSI report 510 from the first communication device 100, the CSI report 510 indicating a subset of CSI coefficients of a set of CSI coefficients based on a CSI omitting rule, the set of CSI coefficients corresponding to one or more of: the set of transmit beams, the set of receive beams and a set of beam pairs comprising the set of transmit beams and the set of receive beams. The second communication device 300 comprises a processor configured to determine the set of CSI coefficients based on the subset of CSI coefficients.

Moreover, in yet another embodiment of the application, the second communication device 300 for a communication system 500 comprises a processor and a memory having computer readable instructions stored thereon which, when executed by the processor, cause the processor to: transmit a set of reference signals in a set of transmit beams of the second communication device 300 to a set of receive beams of a first communication device 100; receive a CSI report 510 from the first communication device 100, the CSI report 510 indicating a subset of CSI coefficients of a set of CSI coefficients based on a CSI omitting rule, the set of CSI coefficients corresponding to one or more of: the set of transmit beams, the set of receive beams and a set of beam pairs comprising the set of transmit beams and the set of receive beams; and determine the set of CSI coefficients based on the subset of CSI coefficients.

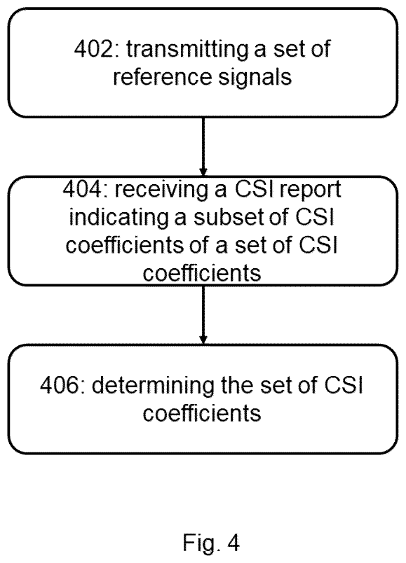

FIG. 4 shows a flow chart of a corresponding method 400 which may be executed in a second communication device 300, such as the one shown in FIG. 3. The method 400 comprises transmitting 402 a set of reference signals in a set of transmit beams of the second communication device 300 to a set of receive beams of a first communication device 100; receiving 404 a CSI report 510 from the first communication device 100, the CSI report 510 indicating a subset of CSI coefficients of a set of CSI coefficients based on a CSI omitting rule, the set of CSI coefficients corresponding to one or more of: the set of transmit beams, the set of receive beams and a set of beam pairs comprising the set of transmit beams and the set of receive beams; and determining 406 the set of CSI coefficients based on the subset of CSI coefficients.

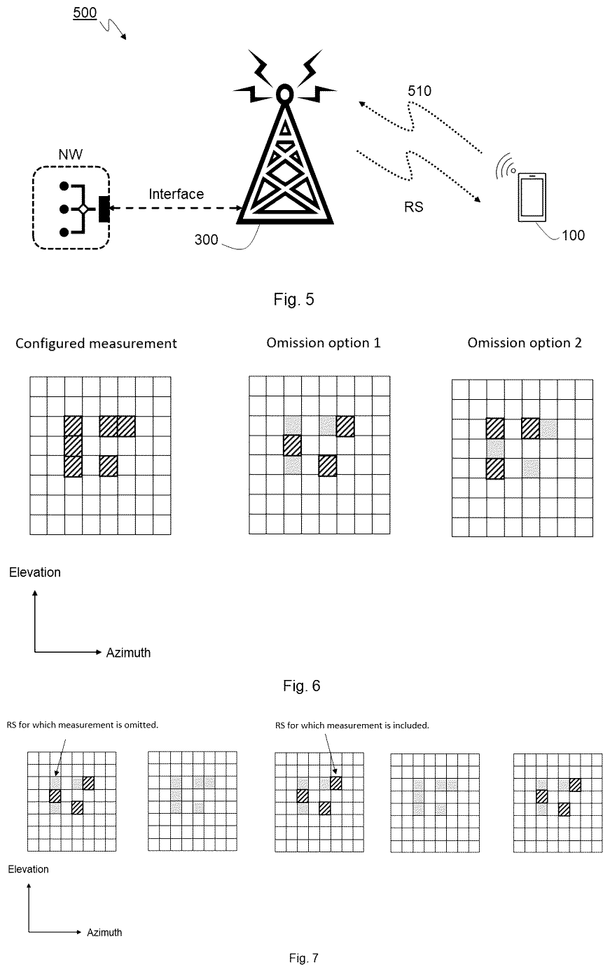

FIG. 5 shows a communication system 500 according to an embodiment of the application. The communication system 500 in the disclosed embodiment comprises a first communication device 100 and a second communication device 300 configured to communicate and operate in the communication system 500 using suitable protocols and communication interfaces. For simplicity, the shown communication system 500 only comprises one first communication device 100 and one second communication device 300. However, the communication system 500 may comprise any number of first communication devices 100 and any number of second communication devices 300 without deviating from the scope of the application.

In the particular example shown in FIG. 5, the first communication device 100 is configured as a client device, such as a UE, while the second communication device 300 is configured as a network access node, such as a base station. The network access node may be part of a radio access network (RAN) and connected to a network (NW), such as a 3GPP core network (CN), via a suitable communication interface. However, the reverse case is also possible, i.e., that the first communication device 100 is configured as a network access node while the second communication device 300 is configured as a client device. In yet further examples of the application which however is not shown in the Figs., both the first communication device 100 and the second communication device 300 may be configured as client devices in sidelink communication scenarios.

According to the present solution, the first communication 100 is configured to receive reference signals (RSs) in receive beams of the first communication device 100. The reference signals may be transmitted in the transmit beams of the second communication device 300 in a downlink (DL) via a suitable air interface. Based on measurements of the received reference signals the first communication device 100 derives and transmits a CSI report 510 to the second communication device 300. The CSI report 510 indicates a subset of CSI coefficients of a complete set of CSI coefficients according to a CSI omitting rule. Thus, it is herein disclosed a solution for reducing the number of CSI coefficients by omitting at least one CSI coefficient according to the CSI omitting rule as the subset of CSI coefficients comprises less CSI coefficients than the complete set of CSI coefficients. Thereby, the payload can be reduced for improved performance in the communication system 500.

The herein presented CSI omitting rule comprises omitting one or more CSI coefficients in the spatial domain and/or in the time domain examples of which are illustrated in FIGS. 6 and 7. In this respect the CSI omitting rule may comprise omitting the CSI coefficient with one or more of a spatial offset, a time offset, a spatial sampling rate and a time sampling rate. Depending on the considered beam or beam pair prediction schemes, one or more of these parameters need to be considered. In time domain beam prediction, the second communication device 300 can use a ML model that predicts beams or beam pairs in the time domain. The input of such ML model can be a time series of measurements per beam or beam pair. When omission happens in this case, the first communication device 100 would reduce the number of reported CSI coefficients by resampling the measured time series, with or without an offset. Thus, in embodiments of the application, the CSI omitting rule comprises omitting one or more CSI coefficients for a time series of CSI coefficients in the set of CSI coefficients.

Typically, the sampling period would be increased and the offset is applied in order to shift the sampling points in time. Ultimately, the sampling period/rate and the offset are chosen by the first communication device 100 so that subsequent interpolation at the second communication device 300 can be performed with enough accuracy.

Assuming that the obtained CSI coefficients/quantities at the first communication device 100 are denoted by

$$[ \begin{matrix}{ρ}_{1 , 1} & … & {ρ}_{1 , T} \\ ⋮ & ⋱ & ⋮ \\ {ρ}_{N , 1} & … & {ρ}_{N , T}\end{matrix} ]$$

wherein ρ_{i,j} refer to the measured L1-RSRP or L1-SINR for reference signal resource i at time j, N refers to the number of DL reference signal resources, and T to the number of measurements over time. Following CSI coefficient omission, with sampling rate γ and offset τ in time domain, the first communication device 100 reports the following measured quantities and the associated beam or beam pair indicators, according to examples of the application,

$${ρ}_{i , j} , i = 1 … N , ∀ j = τ + \frac{n}{γ} , n \leq ( T - τ ) γ .$$

In the case of spatial domain beam or beam pair prediction, the second communication device 300 can use a ML model that predicts beam or beam pair in a large size beam or beam pair codebook based on measurements from a limited size codebook. In this case, the measurement resources are ordered and the sampling rate and offset are applied based on the ordered reference signal resources.

Assuming that the obtained CSI quantities at the first communication device 100 are denoted by

$$[ {ρ}_{1} , … , {ρ}_{N} ] , i = 1 … N$$

wherein ρᵢ refer to the measured L1-RSRP or L1-SINR for reference signal resource i. Following CSI coefficient omission, with sampling rate γ and offset τ in space domain, the first communication device 100 reports the following measured quantities and the associated beam or beam pair indicators, according to examples of the application,

$${ρ}_{i} , ∀ i = τ + \frac{n}{γ} , n \leq ( N - τ ) γ .$$

Other aspects of the present solution relate to which types of beams the present CSI omitting rule is applicable for. The present CSI omitting rule comprises, according to embodiments of the application, omitting the CSI coefficient for one or more of: a transmit beam of the second communication device 300, a receive beam of the first communication device 100, and a beam pair comprising a transmit beam of the second communication device 300 and a receive beam of the first communication device 100. Furthermore, the CSI coefficients of the CSI report 510 may comprises one or more of: a reference resource indicator, a beam index, a reference resource pair indicator, a beam pair index, a reference signal received power (RSRP), and a signal-to-noise and interference ratio (SINR).

FIG. 6 illustrates omission of CSI coefficients in the spatial domain while FIG. 7 illustrates omission of CSI coefficients in the space and time domains. FIGS. 6 and 7 shows reference signal resources, arranged in a grid representing the elevation, on the y-axis and the azimuth, on the x-axis, of the corresponding beam. The gray boxes illustrate RS resources for which measurements are omitted and the angled dashed boxes illustrate RS resources for which measurements are included in the CSI reporting.

FIG. 6 shows two omission options for a set B number of beams both having the same sampling rate but differ in terms of offset. In omission option 1, an offset of 1 resource is considered with a sampling rate of ½. In option omission 2, an offset of 0 resource is considered with a sampling rate of ½. When reporting a reduced CSI report, the first communication device 100 could further indicate the chosen sampling rate and offset to the second communication device 300.

FIG. 7 shows that the CSI coefficient omission in the time domain can be further combined with space domain omission and vice versa. In the time domain, an offset of 0 and a sampling rate of ½ are considered. In the space domain, an offset of 1 resource is considered with a sampling rate of ½.

In yet further embodiments of the application, the CSI omitting rule comprises omitting the CSI coefficient by reducing the set of measured reference signals to a subset of measured reference signals. More particularly, the subset of measured reference signals may be at least one preconfigured reference signal group in channel measurement resources and/or interference measurement resources. The measurement resources in a CSI reporting configuration, which the first communication device 100 measures to compute CSI coefficients, are configured as channel measurement resources (CMR) or interference measurement resources (IMR). CMR are configured in resourcesForChannelMeasurement information element, and IMR is configured in csi-IM-ResourcesForinterference information element and nzp-CSI-RS-ResourcesForinterference information element for zero power and non-zero power interference measurement reference signals, respectively. If the preconfigured reference signal grouping of resources is used, multiple resource groups/sets may be configured in CMR and IMR. Each resource reference signal group/set may have a given priority during the omission procedure.

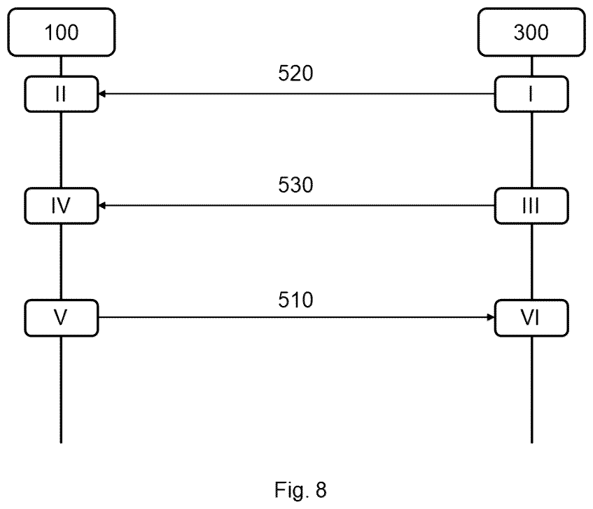

FIG. 8 shows a signaling diagram illustrating signaling aspects of the disclosed solution according to embodiments of the application. It may be noted that some of the described operations in FIG. 8 may be optional operations.

In operation I in FIG. 8, the second communication device 300 transmits a first control signal 520 to the first communication device 100. The first control signal 520 comprises a CSI reporting configuration comprising a CSI omitting rule. The first control signal 520 hence indicates the CSI omitting rule which may relate to omission in the spatial domain, the time domain and/or for preconfigured measuring groups as previously described. The first control signal 520 may be transmitted as a radio resource control (RRC) signal to the first communication device 100.

It should however be mentioned that the CSI reporting configuration may in examples be fully preconfigured in the first communication device 100. In another example, a part of the CSI reporting configuration may be preconfigured in the first communication device 100 while another part or a complementary part of the CSI reporting configuration may be signaled in the first control signal 520.

In operation II in FIG. 8, the first communication device 100 receives the first control signal 520 from the second communication device 300. Based on the CSI omitting rule the first client device 100 prepares and adapts its CSI reporting behaviour which means that the first client device 100 is set to be configured according to the received CSI omitting rule for CSI reporting. However, if the first communication device 100 is already preconfigured with the CSI omitting rule no configuration may be needed.

In operation III in FIG. 8, the second communication device 300 may also transmit second control signal 530 indicating an activation or a deactivation of the CSI omitting rule. Thus, an activation/deactivation mechanism for the CSI omitting rule is provided. By transmitting the second control signal 530 in a downlink control information (DCI) or a downlink medium access control (MAC) control element (CE), the second communication device 300 may control the activation/deactivation in the short time span.

In operation IV in FIG. 8, the first communication device 100 is activated or deactivated to use or not use the configured CSI omitting rule in the first control signal and/or as a preconfigured CSI omitting rule.

In operation V in FIG. 8, the first communication device 100 transmits the CSI report 510 to the second communication device 300. Assuming that the CSI omitting rule has been activated, the CSI report 510 indicates a subset of CSI coefficients of the full or complete set of CSI coefficients as previously described.

In operation VI in FIG. 8, the second communication device 300 determines the set of CSI coefficients based on the subset of CSI coefficients received in the CSI report. A number of different techniques may be employed for deriving the set of CSI coefficients from the subset of CSI coefficients. Two non-limiting examples are by interpolating or extrapolating the subset of CSI coefficients.

For simplifying and speeding up the process of deriving the full or complete set of CSI coefficients, the first communication device 100 may inform the second communication device 300 about which CSI coefficients that have been omitted in the CSI report 510. Thus, the CSI report 510 may in embodiments of the application further indicate information about the omission of the CSI coefficient in the spatial domain and/or in the time domain. That is, information about which particular omission rule that was applied by the first communication device 100 for reducing the number of CSI coefficients. Hence, the CSI report 510 may further indicate any of the following omission information: a spatial offset, a time offset, a spatial sampling rate, and a time sampling rate; and/or the omission of the CSI coefficient by reducing the set of measured reference signals to a subset of measured reference signals based on at least one preconfigured reference signal group in channel measurement resources and/or interference measurement resources.

For example, when a preconfigured reference signal groups has been preconfigured in a CSI reporting configuration, each reference signal group may be given an index, e.g., [0, 1, 2, 3, . . . N]. So, when the first communication device 100 performs reference signal group-based omission of CSI coefficients, the first communication device 100 reduces the number of CSI coefficients and sends CSI coefficients for a number of reference signal groups. In the CSI report 510, the first communication device 100 may indicate the indices of the reference signal groups for which CSI reporting has been performed or not been performed. This information may be needed for two reasons, the second communication device 300 may need to know which reference signal groups were dropped so it can correctly pinpoint the size of the uplink control information (UCI) and decode the UCI correctly. Second, beam indication can be done within reference signal groups, which ultimately reduces overhead. When CSI coefficient omission relates to sampling rate and offset omission, the omission information may be needed so that the second communication device 300 can correctly pinpoint the size of the UCI and decode the UCI correctly. Also, to have the correct mapping in time dimension when performing interpolation at a later operation.

A first communication device 100 herein may also be denoted as a client device or a network access node. Correspondingly, a second communication device 300 herein may also be denoted as network access node or a client device.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method according to embodiments of the application may be implemented in a computer program, having code means, which when run by processing means causes the processing means to execute the operations of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the first communication device and the second communication device comprise the necessary communication capabilities in the form of e.g., functions, means, units, elements, etc., for performing or implementing embodiments of the application. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device and the second communication device may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the application is not limited to the embodiments described above, but also relates to and incorporates all embodiments within the scope of the appended independent claims.

1. A first communication device, comprising:
at least one processor, and at least one memory storing instructions that, when executed by the at least one processor, cause the first communication device to:
measure a set of reference signals transmitted in a set of transmit beams of a second communication device and received in a set of receive beams of the first communication device;
determine a set of channel state information (CSI) coefficients based on the set of measured reference signals;
reduce the set of CSI coefficients to a subset of CSI coefficients by omitting at least one CSI coefficient based on a CSI omitting rule; and
transmit a CSI report to the second communication device, the CSI report indicating the subset of CSI coefficients.

2. The first communication device according to claim 1, wherein the CSI omitting rule comprises omitting the CSI coefficient in at least one of a spatial domain or a time domain.

3. The first communication device according to claim 2, wherein the CSI omitting rule comprises omitting the CSI coefficient with any of: a spatial offset, a time offset, a spatial sampling rate, and a time sampling rate.

4. The first communication device according to claim 2, wherein the CSI omitting rule comprises omitting the CSI coefficient for one or more of: a transmit beam, a receive beam, and a beam pair comprising a transmit beam and a receive beam.

5. The first communication device according to claim 1, wherein the instructions, when executed by the at least one processor, further cause the first communication device to:
receive a first control signal from the second communication device, the first control signal indicating the CSI omitting rule.

6. The first communication device according to claim 1, wherein the instructions, when executed by the at least one processor, further cause the first communication device to:
receive a second control signal from the second communication device, the second control signal indicating an activation or a deactivation of the CSI omitting rule.

7. The first communication device according to claim 1, wherein the CSI report further indicates information about at least one of:
an omission of the CSI coefficient in at least one of a spatial domain or a time domain with any of: a spatial offset, a time offset, a spatial sampling rate, and a time sampling rate; or
an omission of the CSI coefficient by reducing the set of measured reference signals to a subset of measured reference signals based on at least one preconfigured reference signal group in at least one of channel measurement resources or interference measurement resources.

8. A second communication device, comprising:
at least one processor, and at least one memory storing instructions that, when executed by the at least one processor, cause the second communication device to:
transmit a set of reference signals in a set of transmit beams of the second communication device to a set of receive beams of a first communication device;
receive a channel state information (CSI) report from the first communication device, the CSI report indicating a subset of CSI coefficients of a set of CSI coefficients based on a CSI omitting rule, the set of CSI coefficients corresponding to one or more of: the set of transmit beams, the set of receive beams and a set of beam pairs comprising the set of transmit beams and the set of receive beams; and
determine the set of CSI coefficients based on the subset of CSI coefficients.

9. The second communication device according to claim 8, wherein the instructions, when executed by the at least one processor, further cause the second communication device to:
determine the set of CSI coefficients based on interpolating or extrapolating the subset of CSI coefficients.

10. The second communication device according to claim 8, wherein the instructions, when executed by the at least one processor, further cause the second communication device to:
transmit a first control signal to the first communication device, the first control signal indicating the CSI omitting rule.

11. The second communication device according to claim 8, wherein the CSI omitting rule comprises omitting at least one CSI coefficient by reducing the set of reference signals to a subset of reference signals.

12. The second communication device according to claim 8, wherein the instructions, when executed by the at least one processor, further cause the second communication device to:
transmit a second control signal to the first communication device, the second control signal indicating an activation or a deactivation of the CSI omitting rule.

13. The second communication device according to claim 8, wherein the CSI report further indicates information about at least one of:
an omission of at least one CSI coefficient in at least one of a spatial domain or a time domain with any of: a spatial offset, a time offset, a spatial sampling rate, and a time sampling rate; or
an omission of at least one CSI coefficient by reducing the set of reference signals to a subset of reference signals based on at least one preconfigured reference signal group in at least one of channel measurement resources or interference measurement resources.

14. A method for a first communication device, comprising:
measuring a set of reference signals transmitted in a set of transmit beams of a second communication device and received in a set of receive beams of the first communication device;
determining a set of channel state information (CSI) coefficients based on the set of measured reference signals;
reducing the set of CSI coefficients to a subset of CSI coefficients by omitting at least one CSI coefficient based on a CSI omitting rule; and
transmitting a CSI report to the second communication device, the CSI report indicating the subset of CSI coefficients.

15. The method according to claim 14, wherein the CSI omitting rule comprises omitting the CSI coefficient in at least one of a spatial domain or a time domain.

16. The method according to claim 15, wherein the CSI omitting rule comprises omitting the CSI coefficient with any of: a spatial offset, a time offset, a spatial sampling rate, and a time sampling rate.

17. The method according to claim 15, wherein the CSI omitting rule comprises omitting the CSI coefficient for one or more of: a transmit beam, a receive beam, and a beam pair comprising a transmit beam and a receive beam.

18. The method according to claim 14, further comprising:
receiving a first control signal from the second communication device, the first control signal indicating the CSI omitting rule.

19. The method according to claim 14, further comprising:
receiving a second control signal from the second communication device, the second control signal indicating an activation or a deactivation of the CSI omitting rule.

20. The method according to claim 14, wherein the CSI report further indicates information about at least one of:
an omission of the CSI coefficient in at least one of a spatial domain or a time domain with any of: a spatial offset, a time offset, a spatial sampling rate, and a time sampling rate; or
an omission of the CSI coefficient by reducing the set of measured reference signals to a subset of measured reference signals based on at least one preconfigured reference signal group in at least one of channel measurement resources or interference measurement resources.
